(19) United States
(12) Patent Application Publication
(10) Pub. No.: US 2026/0217886 A1
(43) Pub. Date: Jul. 30, 2026

(54) METHOD FOR PRODUCING VINYL ESTER-BASED COPOLYMER

(71) Applicant: Kuraray Co., Ltd., Okayama (JP)

(72) Inventors: Kenji KATAOKA, Houston, TX (US); Ken EGUCHI, Okayama (JP); Makoto OKAMOTO, Okayama (JP)

(73) Assignee: Kuraray Co., Ltd., Okayama (JP)

(21) Appl. No.: 19/142,161

(22) PCT Filed: Dec. 15, 2023
(86) PCT No.: PCT/JP2023/045100

§ 371 Date: Jun. 20, 2025

Related U.S. Application Data
(60) Provisional application No. 63/434,153, filed on Dec. 21, 2022.

(51) Int. Cl. C08F 218/08

(52) U.S. Cl. CPC C08F 218/08; C08F 2800/10

(57) ABSTRACT

Provided is a method for producing a vinyl ester-based copolymer comprising: polymerizing a composition comprising (i) vinyl ester, and (ii) vinyl monomer with a boiling point of 100° C. or higher to produce a copolymer paste, wherein the vinyl ester has a lower boiling point than the vinyl monomer (polymerization step), removing the vinyl ester from the copolymer paste (removing step), evaporating the vinyl monomer in an evaporator by heating the copolymer paste at a pressure of less than 1 atm (evaporation step), and discharging the copolymer paste having a viscosity of 8000 cP or more from the evaporator. By this method, unreacted vinyl monomer remained in the copolymer paste can be recovered effectively.

### TECHNICAL FIELD

The present disclosure relates to a method of producing a vinyl ester-based copolymer.

### BACKGROUND ART

Ethylene-vinyl alcohol copolymers (hereinafter, may be abbreviated as EVOH) are excellent in transparency, a gas barrier property, flavor retention, solvent resistance, oil resistance, and the like, and making good use of such properties, are used for wide use including various packaging containers, such as food packaging containers, medical product packaging containers, industrial chemical packaging containers, and agrochemical packaging containers.

EVOH can be produced by a process that involves a polymerization step in which different monomeric units are reacted together to produce a vinyl ester-based copolymer paste. For example, ethylene, a vinyl ester and a vinyl monomer can be reacted together to form a vinyl ester copolymer, which is then saponified to produce the final EVOH product. This process of producing such EVOHs are explained in detail in U.S. Pat. No. 9,663,592 B2 (PLT-1) and U.S. Pat. No. 7,915,341 B2 (PLT-1), which are incorporated by reference in their entirety.

### CITATION LIST

### Patent Literature

[PTL 1]

U.S. Pat. No. 9,663,592 B2

[PTL 2]

U.S. Pat. No. 7,915,341 B2

### SUMMARY OF INVENTION

### Technical Problem

During the polymerization step, not all of the monomer reactants are used up and incorporated into the polymeric chains. Those monomers that remain unreacted are essentially unused starting materials that would be wasted if not recovered from the final polymeric paste product. Moreover, if discarded into the environment as a waste material, the unreacted monomers may have a harmful effect.

### Solution to Problem

According to some aspects of the present disclosure, a method of producing a vinyl ester-based copolymer includes polymerizing a composition comprising a vinyl ester and vinyl monomer to produce a copolymer paste, removing the vinyl ester from the copolymer paste, and heating the copolymer paste at a reduced pressure and temperature configured to evaporate the vinyl monomer.

In one aspect, the present disclosure relates to a method for producing a vinyl ester-based copolymer comprising: polymerizing a composition comprising (i) vinyl ester, and (ii) vinyl monomer with a boiling point of 100° C. or higher to produce a copolymer paste, wherein the vinyl ester has a lower boiling point than the vinyl monomer (polymerization step), removing the vinyl ester from the copolymer paste (removing step), evaporating the vinyl monomer in an evaporator by heating the copolymer paste at a pressure of less than 1 atm (evaporation step), and discharging the copolymer paste having a viscosity of 8000 cP or more from the evaporator.

In some embodiments, the vinyl ester comprises formula (I) shown below.

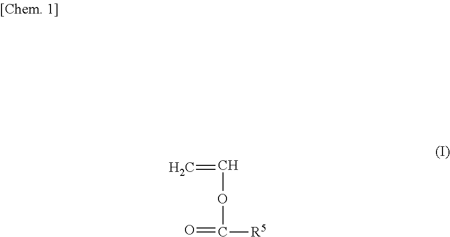

In formula (I), R⁵ is a hydrogen atom or an alkyl group having a carbon number of from 1 to 9. The most preferable vinyl ester is vinyl acetate.

In some embodiments, the vinyl monomer comprises a compound having two or more groups selected from an acyloxy group having a carbon number of from 1 to 10 or a formyloxy group. In other embodiments, the vinyl monomer comprises a compound having a carbon number of from 6 to 20.

In some embodiments, the vinyl monomer comprises formula (II) shown below.

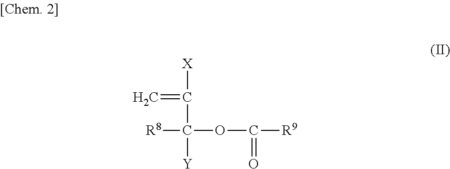

In formula (II), R⁸ is a hydrogen atom or an alkyl group having a carbon number of from 1 to 10, R⁹ is a hydrogen atom or an alkyl group having a carbon number of from 1 to 9, one of X and Y is a hydrogen atom or an alkyl group having a carbon number of from 1 to 10, and the other of X and Y is a group comprises formula (III) shown below.

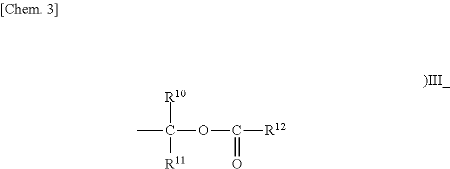

In formula (III), each of R¹⁰ and R¹¹ is independently a hydrogen atom or an alkyl group having a carbon number of from 1 to 10, and R¹² is a hydrogen atom or an alkyl group having a carbon number of from 1 to 9.

In some embodiments, the vinyl monomer comprises formula (IIa) shown below.

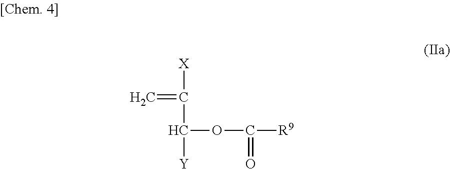

In formula (IIa), R⁹ is a hydrogen atom or an alkyl group having a carbon number of from 1 to 9, one of X and Y is a hydrogen atom, and the other of X and Y is a group comprises formula (IIIa) shown below.

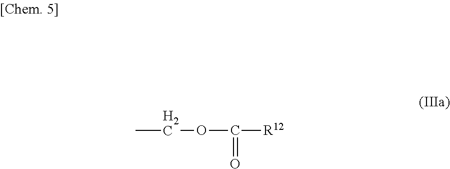

In formula (IIIa), R¹² is a hydrogen atom or an alkyl group having a carbon number of from 1 to 9.

In some embodiments, the vinyl monomer comprises formula (IIb) shown below.

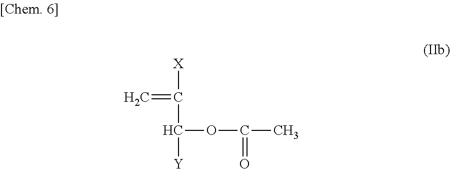

In formula (IIb), one of X and Y is a hydrogen atom, and the other of X and Y comprises a group comprises formula (IIIb) shown below.

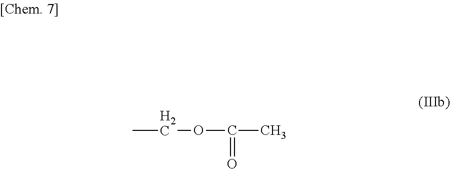

In other embodiments, the vinyl monomer comprises formula (IV) shown below.

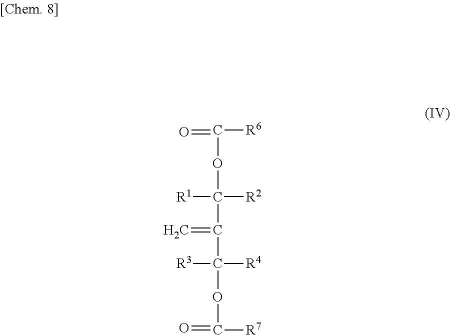

In formula (IV), each of R¹, R², R³, and R⁴ is independently a hydrogen atom or an alkyl group having a carbon number of from 1 to 10, and each of R⁶ and R⁷ is independently a hydrogen atom or an alkyl group having a carbon number of from 1 to 9.

In some embodiments, the vinyl monomer comprises 2-methylene-1,3-propanediol diacetate (MPDAc). In other embodiments, the composition in the polymerization step further comprises ethylene.

In some embodiments, the copolymer paste discharged from the evaporator has a viscosity of 10,000 cP or more and 2,000,000 cP or less. In some embodiments, the temperature of the copolymer paste discharged from the evaporator is 80° C. or more, preferably from 100 to 200° C.

In some embodiments, the method further comprises evaporating a solvent from the copolymer paste after the removing step and before the evaporation step. In some embodiments, the copolymer paste entering the evaporator has a viscosity at 25° C. of 5,000 cP or less, or a viscosity of 500 cP or more and 3,000 cP or less. In some embodiments, the removing step is performed at a different location from the evaporation step. In other embodiments, the evaporation step is performed in a thin film evaporator. In some embodiments, the evaporation step is performed in a Wiped Film Evaporator (WFE).

In some embodiments, the method further comprises collecting the vinyl monomer evaporated in the evaporation step and/or second copolymerization of vinyl ester and the vinyl monomer corrected in the evaporation step. In some embodiments, at least 40% of the vinyl monomer unreacted during the polymerization step is recycled.

In some embodiments, the copolymer paste entering the evaporator contains an organic solvent having a boiling point of less than 100° C. Furthermore, the preferable organic solvent is methanol. In some embodiments, the method further comprises saponifying the copolymer paste discharged from the evaporator. In some embodiments, the vinyl ester-based copolymer has a degree of saponification of at least 90 mol %. In some embodiments, the method further comprises concentrating the vinyl monomer in a condensed liquid evaporated in the evaporation step. In some embodiments, the method further comprises concentrating the vinyl monomer by fraction distillation.

These and other embodiments, features and advantages of the present invention will be more readily understood by those of ordinary skill in the art from a reading of the following detailed description.

### Advantageous Effects of Invention

According to the method for producing a vinyl ester-based copolymer of the present invention, unreacted vinyl monomers remained in the copolymer paste can be recovered effectively.

### DESCRIPTION OF EMBODIMENTS

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a mass or weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 mol % of a comonomer”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

As used herein, the term “block copolymer” refers to copolymers in which chemically distinct monomer units are grouped in discrete blocks along the polymer chain. A block copolymer may comprise two or more homopolymer subunits linked by a covalent bond(s).

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Production of Vinyl Ester-Based Copolymer

The method of producing the vinyl ester-based copolymer according to embodiments of the present disclosure will be described below.

In one aspect, the method comprises polymerizing a composition comprising (i) vinyl ester, and (ii) vinyl monomer with a boiling point of 100° C. or higher to produce a copolymer paste, wherein the vinyl ester has a lower boiling point than the vinyl monomer (polymerization step).

According to some embodiments, the method involves production of a copolymer in a paste form by a polymerization reaction. The copolymer may comprise, for example, the vinyl ester and the vinyl monomer described above. The boiling point of the vinyl monomer may be, for example, more than about 100, 110, 120, 150, or 200° C. and/or less than about 250, 300, 400, or 500° C. In some embodiments, the boiling point of the vinyl monomer may be from 100 to 500° C., from 100 to 300° C., from 150 to 300° C., from 200 to 300° C., or from 200 to 250° C. The vinyl ester in the copolymer has a lower boiling point than the vinyl monomer that is less than about 150, 140, 130, 120, 110, 100, 90, or 80° C. and/or more than about 50, 60, 70° C.

In some embodiments, the vinyl ester included in the copolymer may comprise a monomer represented by formula (I) shown below.

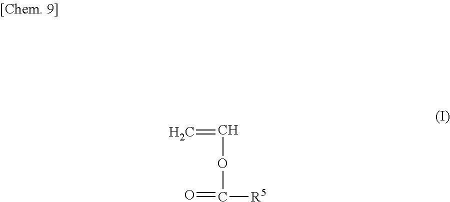

In formula (I), R⁵ denotes a hydrogen atom or an alkyl group having a carbon number of from 1 to 9. A carbon number of the alkyl group is preferably from 1 to 4. Vinyl ester represented by formula (I) is exemplified by vinyl formate, vinyl acetate, vinyl propionate, vinyl butyrate, vinyl isobutyrate, vinyl pivalate, vinyl versatate, vinyl caproate, and the like. In some embodiments, the vinyl ester comprises vinyl acetate.

In some embodiments, the vinyl monomer comprises a compound having two or more groups selected from an acyloxy group having a carbon number of from 2 to 10 or a formyloxy group. The acyloxy groups and the formyloxy group in the copolymer can be changed to hydroxyl group after the saponification process. Therefore, two or more of hydroxyl groups can be introduced into the structural unit derived from the vinyl monomer. Then, the saponified copolymer can have good barrier properties. The carbon number of the acyloxy group is preferably 2 to 5, more preferably 2 to 3, and most preferably 2 (which is acetyloxy group).

In other embodiments, the vinyl monomer comprises a compound having a carbon number of from 6 to 20. If the carbon number of the vinyl monomer is from 6 to 20, the vinyl monomer can be easily evaporated, and the vinyl monomer can be easily divided from the vinyl ester and solvents. The carbon number is preferably 7 or more. The carbon number is preferably 15 or less, more preferably 12 or less, still more preferably 10 or less. The best carbon number is 8.

In some embodiments, the vinyl monomer comprises formula (II) shown below.

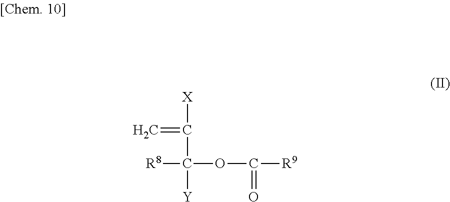

In formula (II), R⁸ is a hydrogen atom or an alkyl group having a carbon number of from 1 to 10. The carbon number of R⁸ is preferably 3 or less, more preferably 2 or less, still more preferably 1 or less. Most preferable R⁸ is a hydrogen atom. R⁹ is a hydrogen atom or an alkyl group having a carbon number of from 1 to 9. The carbon number of R⁹ is preferably 1 to 3, more preferably 1 or 2, still more preferably 1 (which is methyl). One of X and Y is a hydrogen atom or an alkyl group having a carbon number of from 1 to 10, and the other of X and Y is a group comprises formula (III) shown below. This means that, for example, when X is a hydrogen atom or an alkyl group having a carbon number of from 1 to 10, then Y is a group comprises formula (III) shown below. The carbon number of the alkyl group is preferably 3 or less, more preferably 2 or less, still more preferably 1 or less. Most preferable R⁸ is a hydrogen atom.

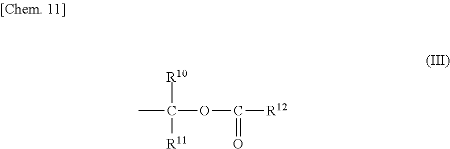

In formula (III), each of R¹⁰ and R¹¹ is independently a hydrogen atom or an alkyl group having a carbon number of from 1 to 10. Each of R¹⁰ and R¹¹ is preferably 3 or less, more preferably 2 or less, still more preferably 1 or less. Most preferable R¹⁰ and R¹¹ are hydrogen atoms. R¹² is a hydrogen atom or an alkyl group having a carbon number of from 1 to 9. The carbon number of R¹² is preferably 1 to 3, more preferably 1 or 2, still more preferably 1 (which is methyl).

In some embodiments, the vinyl monomer comprises formula (IIa) shown below.

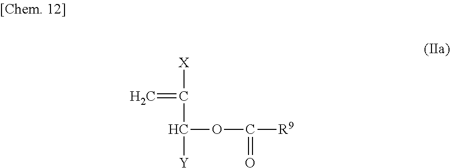

In formula (IIa), R⁹ is a hydrogen atom or an alkyl group having a carbon number of from 1 to 9, one of X and Y is a hydrogen atom, and the other of X and Y is a group comprises formula (IIIa) shown below.

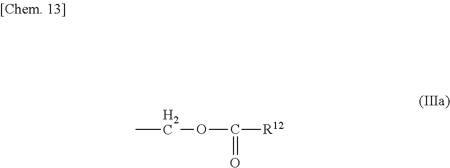

In formula (IIIa), R¹² is a hydrogen atom or an alkyl group having a carbon number of from 1 to 9.

In some embodiments, the vinyl monomer comprises formula (IIb) shown below.

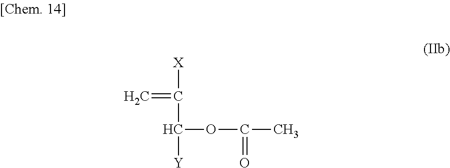

In formula (IIb), one of X and Y is a hydrogen atom, and the other of X and Y comprises a group comprises formula (IIIb) shown below.

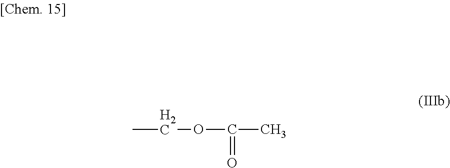

When X comprises a group comprises formula (IIIb) and Y is a hydrogen atom, the vinyl monomer is 2-methylene-1,3-propane diol diacetate which is used in the Examples described later. As the carbon number of this vinyl monomer is 8, its boiling point is adequate for evaporating. Additionally, this vinyl monomer contains two acetyloxy groups in the molecule. Therefore, two hydroxy groups can be introduced into the saponified copolymer. Then, the saponified copolymer has good gas barrier properties and flexibility. These physical properties are well explained in U.S. Pat. No. 9,663,592 B2 (PLT 1).

On the other hand, when X is a hydrogen atom and Y comprises a group comprises formula (IIIb), the vinyl monomer is 3,4-diacetoxy-1-butene. This vinyl monomer has the same molecular weight as 2-methylene-1,3-propane diol diacetate, and has two acetyloxy groups. Therefore, its boiling point is also adequate for evaporating. Then, the saponified copolymer has good gas barrier properties and flexibility. These physical properties are well explained in U.S. Pat. No. 7,915,341 B2 (PLT 2).

In some embodiments, the vinyl monomer may comprise another vinyl ester or another vinyl acetate that has a higher boiling point than the vinyl ester in the copolymer described above. Furthermore, in some embodiments, the vinyl monomer may comprise a monomer represented by formula (IV) shown below.

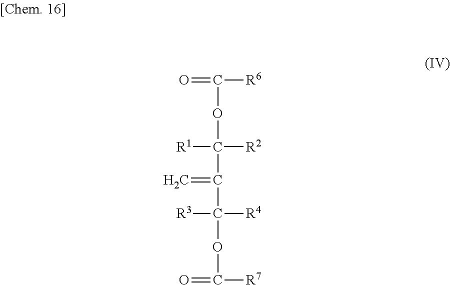

In formula (IV), each of R¹, R², R³, and R⁴ independently denotes a hydrogen atom or an alkyl group having a carbon number of from 1 to 10. R¹, R², R³, and R⁴ may be same groups and may also be different. R¹, R², R³, and R⁴ may be a hydrogen atom or an alkyl group having a carbon number of from 1 to 5.

In formula (IV), each of R⁶ and R⁷ independently denotes a hydrogen atom or an alkyl group having a carbon number of from 1 to 9. A carbon number of the alkyl group may be from 1 to 4. The unsaturated monomer represented by formula (IV) may include 2-methylene-1,3-propanediol diacetate, 2-methylene-1,3-propanediol dipropionate, 2-methylene-1,3-propanediol dibutyrate, and the like. For example, 2-methylene-1,3-propanediol diacetate may be used in view of easy production, in which case R¹, R², R³, and R⁴ are hydrogen atoms and R⁶ and R⁷ are methyl groups. In some embodiments, 2-methylene-1,3-propanediol diacetate (MPDAc).

In addition, instead of the unsaturated monomer represented by the above formula (IV), an unsaturated monomer represented by the following formula (V) may be copolymerized.

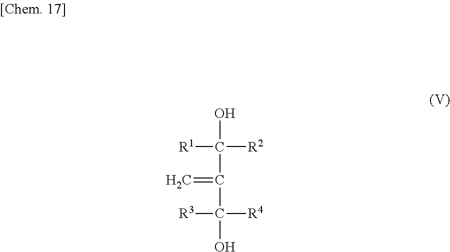

In the formula (V), R¹, R², R³, and R⁴ are same as those in the formula (IV). The unsaturated monomer represented by the formula (V) may include 2-methylene-1,3-propanediol. In the same reason, the vinyl monomer may include 3,4-dihydroxy-1-butene.

The structure of the alkyl group in R¹ to R¹² is not particularly limited and may have a branched structure and a cyclic structure in part. In addition, the alkyl group may include a hydroxyl group, an alkoxy group, or a halogen atom. The alkyl group containing only carbon atom and hydrogen atom is preferable, and the alkyl group having linear structure is also preferable. An example of the alkyl group may include a linear or branched alkyl group, such as a methyl group, an ethyl group, an n-propyl group, an isopropyl group, an n-butyl group, an isobutyl group, a tert-butyl group, and a pentyl group.

The unsaturated monomers represented by the formula (II), (IV) and (V) used in some embodiments have high copolymerization reactivity with vinyl ester monomers so that copolymerization reaction proceeds easily. Accordingly, it is easy to increase an amount of modification and a degree of polymerization of the modified ethylene-vinyl ester copolymer thus obtained. In addition, an amount of the unreacted unsaturated monomers remaining after polymerization is less even when the polymerization reaction is stopped at a low conversion, so that it is excellent in respect of environment and cost. The unsaturated monomers represented by the formula (II), (IV) and (V) are more excellent at this point than other monomers, such as allyl glycidyl ether, having a functional group in an allylic position and having only one carbon atom in an allylic position. Here, the unsaturated monomer represented by the formula (II) and (IV) has higher reactivity than the unsaturated monomer represented by the formula (V).

In some embodiment, the composition in the polymerization step may further comprise an ethylene in addition to the vinyl ester and vinyl monomer, yielding an ethylene-vinyl ester copolymer. The ethylene content of the copolymer may be 1, 5, 10, 15, 20 mol % or more, and 60, 50, 40 mol % or less.

In some embodiments, the mode of polymerization for production of a vinyl ester copolymer by copolymerizing vinyl monomer represented by the above formula (I), and the unsaturated monomer represented by the above formula (II), (IV) or (V) may be any of batch polymerization, semi-batch polymerization, continuous polymerization, and semi-continuous polymerization. In addition, as the method of polymerization, it is possible to employ a known method, such as a bulk polymerization method, a solution polymerization method, a suspension polymerization method, and an emulsion polymerization method. A bulk polymerization method or a solution polymerization method is usually employed, in which polymerization proceeds without solvent or in a solvent, such as alcohol. In a case of obtaining a modified ethylene-vinyl ester copolymer with a high degree of polymerization, employment of an emulsion polymerization method becomes an option. In the case of the solution polymerization method, an amount of solvent in a polymerization reaction liquid may be selected considering the intended viscosity average degree of polymerization of the resulting polymer and chain transfer of the solvent, and a weight ratio of the solvent to the total monomers contained in the reaction liquid (solvent/total monomers) is selected from a range of from 0.01 to 10, preferably a range of from 0.05 to 3.

A polymerization initiator used for copolymerization of vinyl ester represented by the above formula (I), and the unsaturated monomer represented by the above formula (II), (IV) or (V) is selected in accordance with the method of polymerization from known polymerization initiators, for example, an azo initiator, a peroxide initiator, and a redox initiator. The azo initiator may include, for example, 2,2′-azobisisobutyronitrile, 2,2′-azobis(2,4-dimethylvaleronitrile), and 2,2′-azobis(4-methoxy-2,4-dimethylvaleronitrile). The peroxide initiator may include, for example, percarbonate compounds, such as diisopropyl peroxydicarbonate, di-2-ethylhexyl peroxydicarbonate, and diethoxyethyl peroxydicarbonate; perester compounds, such as t-butylperoxy neodecanoate, α-cumylperoxy neodecanoate, and acetyl peroxide; acetylcyclohexylsulfonyl peroxide; 2,4,4-trimethylpentyl-2-peroxyphenoxyacetate; and the like. Potassium persulfate, ammonium persulfate, hydrogen peroxide, and the like may also be used in combination with the above initiators. The redox initiator is a polymerization initiator in which, for example, the above peroxide initiators and a reducing agent, such as sodium hydrogen sulfite, sodium hydrogen carbonate, tartaric acid, L-ascorbic acid, and rongalite, are combined. An amount of polymerization initiator use is different depending on the polymerization catalyst and thus is not determined unconditionally, and it is adjusted in accordance with the conversion. The amount of polymerization initiator based on vinyl ester monomers may be from 0.01 to 0.2 mol % or may be from 0.02 to 0.15 mol %. Although the polymerization temperature is not particularly limited, it is appropriately from room temperature to 150° C. approximately, and not less than 40° C. and not more than a boiling point of a solvent to be used.

For copolymerization of vinyl ester represented by the above formula (I), and the unsaturated monomer represented by the above formula (II), (IV) or (V), they may be copolymerized in the presence of a chain transfer agent as long as not inhibiting the effects of the present invention. The chain transfer agent may include, for example, aldehydes, such as acetaldehyde and propionaldehyde; ketones, such as acetone and methylethylketone; mercaptans, such as 2-hydroxyethanethiol; and phosphinates, such as sodium phosphinate monohydrate. Among all, aldehydes and ketones are used preferably. Although an amount of adding the chain transfer agent to the polymerization reaction liquid is determined in accordance with the chain transfer constant of the chain transfer agent and the intended degree of polymerization of the modified ethylene-vinyl ester copolymer, it may be from 0.1 to 10 parts by mass based on 100 parts by mass of the vinyl ester monomer in general.

After the polymerization step, unreacted vinyl ester is removed from the copolymer paste (removing step). The method for removing vinyl ester is not specifically limited. In some embodiments, the removing step is performed at a different location from the evaporation step explained below. For example, the removing step is performed in a different machine or a different compartment in the same evaporator from the evaporating step. One of the preferable method for removing step is contacting solvent vapor with the copolymer paste, then evaporating the vapor of the vinyl ester together with the solvent vapor. This method is suitable for large scale continuous production, and the resulting copolymer paste after the removing step usually contains about 50 wt % of solvent. In the preferable embodiment, vinyl acetate vapor is evaporated from the copolymer paste together with methanol vapor. The removed vinyl ester can then be recovered and recycled by, for example, using it in a second round of polymerization that may generate additional copolymer paste.

In some embodiments, the method further comprising evaporating a solvent from the copolymer paste after the removing step and before the evaporation step. By evaporating part of the solvent, the viscosity of the copolymer paste entering the evaporator cab be controlled in an adequate range mentioned below. Additionally, it is not efficient to evaporate vinyl monomer together with large amount of solvent in the evaporation step.

As explained above, the copolymer paste entering the evaporator contains a solvent. A solvent used in a solution polymerization method may be contained. The solvent is not particularly limited, an alcohol or mixtures of different alcohols may be used, including a lower alcohol such as methanol, ethanol, and propanol. In some embodiments, the solvent comprises methanol. The solvent may be an organic solvent having a boiling point of more than about 10, 30, 50, 60° C. and/or less than about 70, 80, 90, or 100° C. In some embodiments, the solvent may be an organic solvent having a boiling point from 10 to 100° C., from 50 to 90° C., or from 60 to 90° C. In some embodiments, the copolymer paste contains an organic solvent having a boiling point of less than 100° C.

The resulting copolymer paste from the removing step described above may be a viscous material. In some embodiments, the resulting copolymer paste, for example, before entering an evaporator has about 500, 600, 650, 700 cp or more and/or about 10,000, 9,000, 8,000, 7,000, 5,000, 3,000, 2,000, 1,000, 900 cp or less at room temperature (25° C.).

The copolymer paste entering the evaporator according to some embodiments may have the viscosity as described above. In some embodiments, the copolymer paste entering the evaporator according to some embodiments may have a viscosity of 5,000 cP or less at room temperature (25° C.). In some embodiments, the copolymer paste entering the evaporating may have a viscosity of 4,000 cP or less at room temperature (25° C.). In some embodiments, the copolymer paste entering the evaporating has a viscosity of 500 cP or more and 3,000 cP or less at room temperature (25° C.).

In the evaporation step, the vinyl monomer is evaporated by heating the copolymer paste at a pressure of less than 1 atm in an evaporator. Any evaporator operated under reduced pressure and high temperature can be used. In some embodiments, the evaporator is a thin film evaporator. The thin film evaporator is suitable for handling viscous paste.

In some embodiments, the vaporator described herein a wiped film evaporator (WFE), such as Filmtruder manufactured by LCI (lcicorp.com/en-us/evaporation-equipment/high-viscosity-processor) or a similar device from Kobelco (kobelco-eco.co.jp/process_equipment/pdf/product/exeva.pdf). In some embodiments, the evaporating and the removing described herein are performed in the evaporator at different locations.

The copolymer paste discharged from the evaporator may have a paste viscosity of about 8,000, 10,000, 11,000, 12,000, 15,000, 20,000, 30,000, 40,000, 45,000, 46,000, 50,000, 60,000, 70,000, 100,000, 200,000, 500,000, 1,000,000, 1,300,000 cP or more and/or about 1,600,000, 1,700,000, 2,000,000, 10,000,000, 9,000,000, 8,000,000, 7,000,000, 6,000,000, 5,000,000, 4,000,000, 3,000,000 cP or less. In some embodiments, a viscosity range for the paste described herein is from about 8,000 to about 25,000,000 cP. In some embodiments, a viscosity range for the paste described herein is from about 10,000 to about 2,000,000 cP. In some embodiments, a viscosity range for the paste described herein is from about 10,000 to about 16,000,000 cP. In some embodiments, a viscosity range for the paste described herein is from about 46,000 to about 16,000,000 cP. In some embodiments, a viscosity range for the paste described herein is from about 44,000 to about 20,000,000 cP. In some embodiments, a viscosity range for the paste described herein is from about 1,000,000 to about 10,000,000 cP. If the viscosity of the copolymer paste discharged from the evaporator is too high, discharging operation may become difficult. On the other hand, if the viscosity of the copolymer paste discharged from the evaporator is too low, the vinyl monomer may not be evaporated efficiently, and the recovery rate may become low.

In some embodiments, removing the vinyl monomer having a higher boiling point than the vinyl ester in the copolymer paste described herein is achieved by applying heat to the copolymer paste. The heating may be performed in a reduced pressure environment to vaporize the vinyl monomer from the paste. For example, the copolymer discharged from the evaporator is more than about 80, 90, 100, 110, 120, 130, or 140° C. and/or less than 150, 170, 200, 250, 300, 350, 400, or 500° C. to vaporize the vinyl monomer. Moreover, a reduced pressure may be applied to facilitate the evaporation, such as a pressure of more than about 0.01 atm (or about 7.6 torr), about 0.05 atm (or about 38 torr), about 0.1 atm (or about 76 torr), about 0.2 atm (or about 150 torr), and/or less than about 0.3 atm (or about 230 torr), about 0.4 atm (or about 300 torr), about 0.5 atm (or about 380 torr), about 0.6 atm (or about 460 torr), about 0.7 atm (or about 530 torr), about 0.8 atm (or about 610 torr), about 0.9 atm (or about 680 torr), or about 1.0 atm (or about 760 torr).

In some embodiments, the unreacted vinyl ester and/or vinyl monomer may be recovered for reuse or recycling. Accordingly, some embodiments include removing the vinyl ester from the copolymer paste produced from the polymerization of the vinyl ester and the vinyl monomer.

The embodiments may further or alternatively include treating or heating the copolymer paste to remove the vinyl monomer from the paste.

The recovery and collection of the vinyl monomer may be performed in the evaporator describe herein, including a thin film evaporator or a wiped film evaporator (WFE), such as Filmtruder manufactured by LCI (lcicorp.com/en-us/evaporation-equipment/high-viscosity-processor) or a similar device from Kobelco (kobelco-eco.co.jp/process_equipment/pdf/product/exeva.pdf). The recovery rate of the vinyl monomer achieved may be at least about 1%, about 5%, about 10%, about 20%, about 30%, about 40%, about 50%, or about 60% of unused vinyl monomer after polymerization reaction. In some embodiments, at least 40% of the vinyl monomer unreacted during the polymerization step is recycled.

The recycle rate (%) disclosed herein can be calculated by the following equations:

Recycled vinyl monomer/unreacted vinyl monomer after polymerization×100; or

(Flow rate of distilled liquid from evaporator (e.g. WFE)×vinyl monomer concentration in the distilled liquid from the evaporator)/(Feeding rate of paste into the evaporator×vinyl monomer concentration in feeding liquid into the evaporator)×100.

The recovered vinyl monomer can then be recycled by, for example, using it in a second round of polymerization that may generate additional copolymer paste. Accordingly, relative to a production method without the recovery and collection of the vinyl ester and the vinyl monomer, it is possible to improve the production efficiency and achieve an increased amount of copolymer paste from the same amount of the starting materials, and it is also possible to reduce the negative impact that the unreacted monomer may have on the environment that would otherwise have been discarded as waste. In some embodiments, the vinyl monomer evaporated in the evaporation step is collected for a later use or is returned directly in the polymerization step described herein.

In some embodiments, the copolymer paste discharged from the evaporator may be saponified. It is possible to employ a known method for a method of saponifying the vinyl ester copolymer paste. The saponification reaction is usually carried out in an alcohol or hydrous alcohol solution. Alcohol used at this time may be a lower alcohol, such as methanol and ethanol, and propanol. Alcohol or hydrous alcohol used for the saponification reaction may contain another solvent, such as acetone, methyl acetate, ethyl acetate, and benzene, as long as the solvent is not more than 40 weight % of its weight. The catalyst used for the saponification is, for example, alkali metal hydroxides, such as potassium hydroxide and sodium hydroxide; alkali metal alkoxide, such as sodium methylate; and acid catalysts, such as mineral acid. Although the temperature to carry out the saponification is not limited, the temperature may be in a range of from 20, 30, 40, 50, or 60° C. to 60, 70, 80, 90, 100, 110, or 120° C. In some embodiments, the vinyl ester-based copolymer described herein may have a degree of saponification of at least 90, 91, 92, 93, 94, 95, 96, 97, 98 or 99 mol %.

Additionally, some embodiments may include concentrating the vinyl monomer in a condensed liquid evaporated in the evaporation step, and then saponifying. Concentrating the vinyl monomer may be achieved by fractional distillation technology. The fractional distillation technology may be used to concentrate the vinyl monomer after evaporating vinyl monomer before its recycled polymerization. The distillate may be further subjected to condensation, which removes solvents such as methanol and further concentrates the recovered vinyl monomer.

### EXAMPLES

Although further detailed descriptions are given below to the present invention by Examples, the present invention is not limited to Examples.

Vinyl acetate, ethylene and 2-methylene-1,3-propanediol diacetate were used as vinyl monomers. The vinyl monomer A having a boiling point of 100° C. or higher is 2-methylene-1,3-propanediol diacetate (MPDAc), and the solvent having a boiling point of less than 100° C. is methanol (hereinafter referred to as MeOH). The boiling point of MPDAc is 225° C., and the boiling point of MeOH is 65° C.

### 1. Polymerization Step (1)

100 kg of vinyl acetate, 2.7 kg of MeOH, 5.2 kg of 2-methylene-1,3-propane diol diacetate were added in a 200 L pressurized reaction tank equipped with a jacket, an agitator, a nitrogen inlet, an ethylene inlet and an initiator addition port. Temperature was raised to 60° C., and then nitrogen bubbling was performed for 30 minutes to replace the interior atmosphere of the reaction vessel with nitrogen. Next, ethylene was introduced so that the reaction vessel pressure (ethylene pressure) was 5.3 MPa. After adjusting the temperature in the reaction vessel to 60° C., polymerization was initiated by adding a methanol solution of 0.1 kg of 2,2′-azobis(2,4-dimethylvaleronitrile) (“V-65” manufactured by Wako Pure Chemical Industries, Ltd.) as an initiator. During polymerization, ethylene pressure was maintained at 5.3 MPa and the polymerization temperature was maintained at 60° C. After 6 hours, when the polymerization rate of VAc reached 42%, the mixture was cooled to terminate polymerization. After opening the reaction vessel and removing ethylene, nitrogen gas was bubbled to further and completely remove ethylene. Then, after removing unreacted VAc under reduced pressure, MeOH was added to the modified ethylene-vinyl acetate copolymer (hereinafter referred to as modified EVAc) into which the structural unit derived from MPDAc was introduced by copolymerization to obtain a MeOH solution. The MeOH solution contains 29.7 wt % of modified EVAc and 0.94 wt % of MPDAc. The viscosity of the MeOH solution at 25° C. is 700 cP. The method for measuring the MeOH solution is explained in “5. Viscosity measurement method” shown below.

### 2. Content of Each Structural Unit in Modified EVAc

Ethylene content (a mol %), vinyl acetate-derived structural unit content (b mol %) and MPDAc-derived structural unit content (c mol %) in the modified EVAc were calculated by 1H-NMR measurement of modified EV Ac before saponification.

First, a small amount of the MeOH solution of the modified EVAc obtained in polymerization step (1) was sampled, and the modified EVAc was precipitated in ion-exchanged water. The precipitate was collected and dried under vacuum at 60° C. to obtain a dried product of modified EVAc. Next, the obtained dried product of modified EVAc was dissolved in dimethyl sulfoxide (DMSO)-d₆ containing tetramethylsilane as an internal standard substance and was measured using 1H-NMR at 500 MHz (manufactured by JEOL Ltd.: “GX-500”) at 80° C.

The ¹H-NMR spectrum of the modified EVAc was obtained in Example 1. Each peak in the spectrum is assigned as follows.
0.6 to 1.0 ppm: Methylene proton (4H) in ethylene units at the terminal site.
1.0 to 1.85 ppm: Methylene proton (4H) as an intermediate site ethylene unit, main chain site methylene proton (2H) as a structural unit derived from MPDAc, methylene proton as a vinyl acetate unit (2H).
1.85-2.1 ppm: Methyl proton (6H), which is a structural unit derived from MPDAc, and methyl proton (3H), which is a vinyl acetate unit.
3.7-4.1 ppm: Side chain site methylene proton (4H) of structural unit derived from MPDAc
4.4-5.3 ppm: Methine proton (1H) in vinyl acetate unit.

According to the above attribution, when the integral value of 0.6 to 1.0 ppm is x, the integral value of 1.0 to 1.85 ppm is y, the integral value of 3.7-4.1 ppm is z, and the integral value of 4.4-5.3 ppm is w, the content of ethylene unit (a: mol %), the content of vinyl ester unit (b: mol %), and the content of structural unit derived from MPDAc (c: mol). %) were calculated according to the following formulas:

$$a = ( 2 x + 2 y - z - 4 w ) / ( 2 x + 2 y + z + 4 w ) \times 100$$

$$b = 8 w / ( 2 x + 2 y + z + 4 w ) \times 100$$

$$c = 2 z / ( 2 x + 2 y + z + 4 w ) \times 100$$

As a result of calculation by the above method, the content of ethylene unit (a) was 38.0 mol %, the content of vinyl ester unit (b) was 59.5 mol %, and the content of structural units derived from MPDAc (c) was 2.5 mol %. The values of a, b and c in the modified EVAc are the same as the values of a, b and c in the modified EVOH after the saponification treatment.

From the analysis results of 1H-NMR, it was calculated that, of the added 5.2 kg of 2-methylene-1,3-propanediol diacetate, 3.4 kg was converted to modified EVAc and consumed and 1.8 kg remained unreacted in the methanol solution of modified EVAc. The composition of the MeOH solution of the modified EVAc was EVAc/MeOH/vinyl monomer A=30/69/1 (weight ratio).

### 3. Evaporation Step of Vinyl Monomer a (2)

In the evaporation step of 2-methylene-1,3-propanediol diacetate, which is vinyl monomer A, EXEVA manufactured by Shinko Environmental Solution Co., Ltd., a thin film evaporator equipped with a multi-stage inclined stirring blade (0.2 m² effective transmission surface) was used. The MeOH solution of the modified EVAc prepared in the polymerization step (1) was charged in a 50 L storage tank equipped with a stirrer, and the MeOH solution of modified EVAc was fed to the thin film evaporator at a liquid feeding rate described in Table 1 using a gear pump. When the liquid feeding rate is low, the retention time in the evaporator becomes long, and then higher recovery rate will be achieved. MeOH and 2-methylene-1,3-propanediol diacetate were evaporated by maintaining the interior of the thin film evaporator at a pressure described in Table 1. And the temperature of heat media for heating the evaporator is described in Table 1. The vapor evaporated from the thin film evaporator was condensed with a condenser cooled to 2° C., and the weight of the condensed liquid was measured. On the other hand, the modified EVAc paste concentrated by the thin film evaporator was discharged from the lower part of the thin film evaporator to the outside of the system by a gear pump, and the weight, modified EVAc content, temperature, and viscosity were measured. The method for measuring the viscosity of the modified EVAc paste is explained in “5. Viscosity measurement method” shown below. The results are summarized in Table 1. The temperature of the discharged copolymer paste in Example 1 was higher than the temperature of the heat media because of the shear exotherm.

TABLE 1

| | | | | | | | Comp. |
|---|---|---|---|---|---|---|---|
| | | Unit | Exam. 1 | Exam. 2 | Exam. 3 | Exam. 4 | Exam. 1 |
| Evaporation | liquid feeding rate | L/hr | 12 | 10 | 15 | 23 | 20 |
| condition | pressure | torr | 66 | 200 | 66 | 200 | 66 |
| | media temperature | ° C. | 130 | 110 | 130 | 130 | 130 |
| Discharged | temperature | ° C. | 147 | 121 | 67 | 37 | 36 |
| paste | viscisity | cP | 1,600,000 | 1,300,000 | 46,000 | 10,000 | 3,800 |
| | EVAc content | wt % | =100 | 96 | 78 | 69 | 63 |
| Condenced | MPDAc content | wt % | 0.97 | 0.89 | 0.076 | 0.030 | 0.016 |
| liquid | recovery rate | % | 72 | 65 | 5.0 | 1.8 | 0.9 |

### 4. Measurement of 2-Methylene-1,3-Propanediol Diacetate Concentration in the Condensed Liquid Obtained in the Evaporation Step (2)

The concentration of 2-methylene-1,3-propanediol diacetate was measured using Gas Chromatography-Mass Spectrometry (“GC-MS”). The measurement conditions are shown below.
GC: GC2014 manufactured by Shimadzu Corporation
GC column: Agilent J & W, DB-1701 (14%-cyanopropylphenyl)-methylpolysiloxane for low/medium polarity (50 m×0.32 mm)
Injection temperature: 250° C.
Carrier: helium
Column temperature 5 minutes at 50° C.→ from 50 to 230° C. (15° C./minute)→30 minutes at 230° C.

As a result of analysis by GC, the concentration of 2-methylene-1,3-propanediol diacetate in the condensed liquid were listed in Table 1. The recovery rate of 2-methylene-1,3-propanediol diacetate were calculated and listed in Table 1. The recovery rate was calculated according to “6. Method of calculating recovery rate” shown below.

### 5. Viscosity Measurement Method

1) Fixed Concentration Greater than 40%

The viscosity at a shear rate of 10 sec-1 was measured using a rheometer manufactured by TA Instruments Japan Co., Ltd. at the same temperature as the operating temperature.

2) Fixed Concentration Less than 40%

After heating the sample to the same temperature as the operating temperature, a ⅛ steel ball was dropped, the time required to pass the measurement section of 5 cm was measured, and the viscosity was calculated from Stokes' equation.

Vs=Dp²(ρp−ρf)g/18η
Vs: terminal speed; [m/s]
Dp: Diameter of falling ball; [m]
ρp: Density of falling ball; [kg/m³]
ρf: Density of modified EVAc MeOH solution; [kg/m³]
g: Gravitational acceleration; [m/s²]
η: liquid viscosity; [Pa·s] (1 mPa·s=1 cP)

### 6. Method of Calculating Recovery Rate

Recovery rate=Outflow rate of distillate×MPDAc concentration in distillate/Feed rate of paste×MPDAc concentration in paste

In Examples 1 to 4, the solution viscosity of the modified EVAc pastes discharged from the evaporator were 10,000 cP or more, and 2-methylene-1,3-propanediol diacetate, the vinyl monomer A, can be evaporated, enabling separation and recovery from the modified EVAc. In comparative Example 1 in which EVAc content was 63% and the solution viscosities was 3,800 cP, minimal amount of 2-methylene-1,3-propanediol diacetate was recovered.

### 7. Reuse of Vinyl Monomer A Contained in the Condensed Liquid in the Evaporation Step (2) in the Polymerization Step (1)

1.2 kg of 2-methylene-1,3-propanediol diacetate was successfully recovered from the modified EVAc corresponding to one round of the polymerization step (1) by concentrating the condensed liquid obtained in the evaporation step (2), Example 2. Polymerization was carried out using the same conditions as in the polymerization step (1), except that 1.2 kg of the previously taken-out 2-methylene-1,3-propanediol diacetate and 4.0 kg of the unused 2-methylene-1,3-propanediol diacetate were used. The polymerization proceeded without any problems, and the same modified EVAc as in the polymerization step (1) of Example 1 was obtained. Of the 1.8 kg of 2-methylene-1,3-propanediol diacetate remaining unreacted in the polymerization step (1), 1.2 kg could be effectively used. In other words, out of the 5.2 kg charged in the polymerization step (1), 3.4 kg was used for the modification reaction in the polymerization step (1), and 1.2 kg was recovered and could be used again for the polymerization. The usage rate is 88%.

### 8. Saponification of Modified EVAc

A 10 L reaction vessel equipped with a jacket, a stirrer, a nitrogen inlet, a reflux condenser and a solution addition port was charged with 5 kg of a 20 mass % MeOH solution of the modified EVAc obtained in Examples 1-4. The temperature was raised to 60° C. while blowing nitrogen into this solution, and a MeOH solution having a sodium hydroxide concentration of 2 mol/L was added at a rate of 14.7 mL/min for 2 hours. After the addition of the MeOH solution of sodium hydroxide was completed, the saponification reaction was allowed to proceed by stirring for 2 hours while maintaining the in-system temperature at 60° C. Then, 0.25 kg of acetic acid was added to stop the saponification reaction. Then, while heating and stirring at 80° C., 3 L of ion-exchanged water was added to allow MeOH to flow out of the reaction vessel to precipitate a modified ethylene-vinyl alcohol copolymer (hereinafter referred to as modified EVOH). The modified EVOH precipitated by decantation was collected and ground with a mixer. The obtained modified EVOH powder was put into a 1 g/L acetic acid aqueous solution (bath ratio 20: ratio of 20 L of aqueous solution to 1 kg of powder) and washed by stirring for 2 hours. Liquid was removed from this mixture, then a 1 g/L acetic acid aqueous solution (bath ratio 20) was added and stirred and washed for 2 hours. The product that remained after removing liquid was put into ion-exchanged water (bath ratio 20), stirred and washed for 2 hours, and removal of liquid was repeated 3 times for purification. The resulting product was immersed in 10 L of an aqueous solution containing 0.5 g/L of acetic acid and 0.1 g/L of sodium acetate and stirred for 4 hours, after which liquid was removed. The remaining product was dried for 16 hours at 60° C., resulting in 0.5 kg of dried crude modified EVOH. The degree of saponification of the modified EVOH is 99 mol %.

### Comparative Example 2

The polymerization step (1) was carried out under the same conditions, and after distilling off the unreacted VAc, the evaporation step of the vinyl monomer A was not carried out. Of the 5.2 kg charged in the polymerization step (1), 3.4 kg was used for the modification reaction and 1.8 kg was unreacted and was not used without being recovered, leading to a usage rate of 65%.

1. A method for producing a vinyl ester-based copolymer comprising:
polymerizing a composition comprising (i) vinyl ester, and (ii) vinyl monomer with a boiling point of 100° C. or higher to produce a copolymer paste, wherein the vinyl ester has a lower boiling point than the vinyl monomer (polymerization step),
removing the vinyl ester from the copolymer paste (removing step),
evaporating the vinyl monomer in an evaporator by heating the copolymer paste at a pressure of less than 1 atm (evaporation step), and
discharging the copolymer paste having a viscosity of 8000 cP or more from the evaporator.

2. The method according to claim 1, wherein the vinyl ester comprises formula (I): 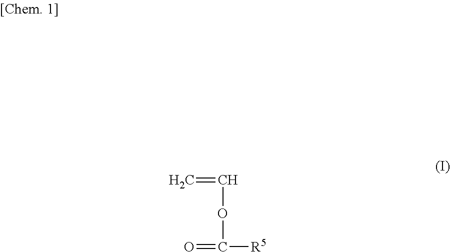
in which R⁵ is a hydrogen atom or an alkyl group having a carbon number of from 1 to 9.

3. The method according to claim 1, wherein the vinyl ester comprises vinyl acetate.

4. The method according to claim 1, wherein the vinyl monomer comprises a compound having two or more groups selected from an acyloxy group having a carbon number of from 1 to 10 or a formyloxy group.

5. The method according to claim 1, wherein the vinyl monomer comprises a compound having a carbon number of from 6 to 20.

6. The method according to claim 1, wherein the vinyl monomer comprises formula (II): 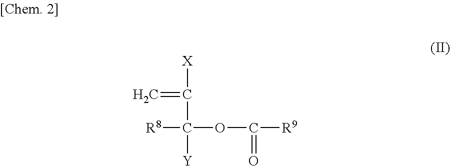
in which R⁸ is a hydrogen atom or an alkyl group having a carbon number of from 1 to 10, R⁹ is a hydrogen atom or an alkyl group having a carbon number of from 1 to 9, one of X and Y is a hydrogen atom or an alkyl group having a carbon number of from 1 to 10, and the other of X and Y is a group comprises formula (III): 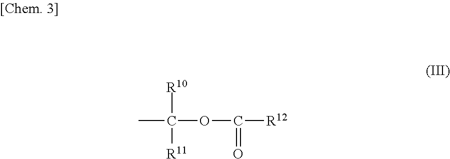
in which each of R¹⁰ and R¹¹ is independently a hydrogen atom or an alkyl group having a carbon number of from 1 to 10, and R¹² is a hydrogen atom or an alkyl group having a carbon number of from 1 to 9.

7. The method according to claim 6, wherein the vinyl monomer comprises formula (IIa): 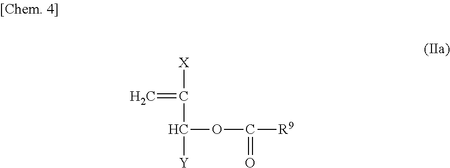
in which R⁹ is a hydrogen atom or an alkyl group having a carbon number of from 1 to 9, one of X and Y is a hydrogen atom, and the other of X and Y is a group comprises formula (IIIa): 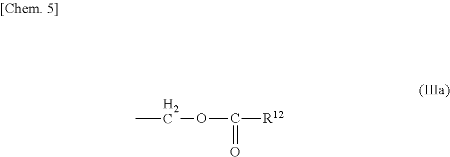
in which R¹² is a hydrogen atom or an alkyl group having a carbon number of from 1 to 9.

8. The method according to claim 7, wherein the vinyl monomer comprises formula (IIb): 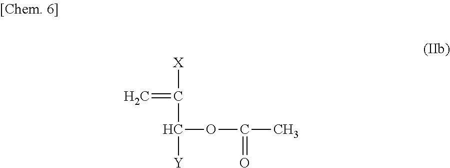
in which one of X and Y is a hydrogen atom, and the other of X and Y comprises a group comprises formula (IIIb):

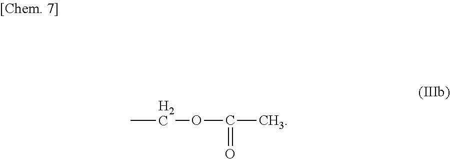

9. The method according to claim 1, wherein the vinyl monomer comprises formula (IV): 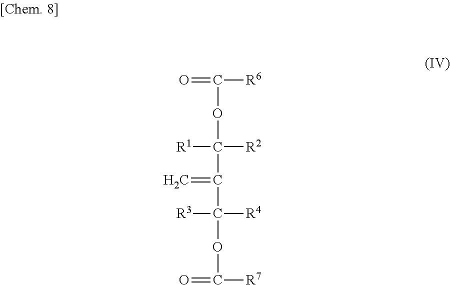
in which each of R¹, R², R³, and R⁴ is independently a hydrogen atom or an alkyl group having a carbon number of from 1 to 10, and each of R⁶ and R⁷ is independently a hydrogen atom or an alkyl group having a carbon number of from 1 to 9.

10. The method according to claim 8, wherein the vinyl monomer comprises 2-methylene-1,3-propanediol diacetate (MPDAc).

11. The method according to claim 1, wherein the composition in the polymerization step further comprises ethylene.

12. The method according to claim 1, wherein the copolymer paste discharged from the evaporator has a viscosity of 10,000 cP or more and 2,000,000 cP or less, and the temperature of the copolymer paste discharged from the evaporator is 80° C. or more.

13. (canceled)

14. The method according to claim 1, further comprising evaporating a solvent from the copolymer paste after the removing step and before the evaporation step.

15. The method according to claim 1, wherein the copolymer paste entering the evaporator has a viscosity at 25° C. of 5,000 cP or less.

16. (canceled)

17. The method according to claim 1, wherein the removing step is performed at a different location from the evaporation step.

18. The method according to claim 1, wherein the evaporation step is performed in a thin film evaporator.

19. (canceled)

20. The method according to claim 1, further comprising collecting the vinyl monomer evaporated in the evaporation step.

21. The method according to claim 20, further comprising second copolymerization of vinyl ester and the vinyl monomer corrected in the evaporation step.

22. The method according to claim 1, wherein at least 40% of the vinyl monomer unreacted during the polymerization step is recycled.

23. The method according to claim 1, wherein the copolymer paste entering the evaporator contains an organic solvent having a boiling point of less than 100° C.

24-26. (canceled)

27. The method according to claim 1, further comprising concentrating the vinyl monomer in a condensed liquid evaporated in the evaporation step.

28. The method according to claim 27, further comprising concentrating the vinyl monomer by fraction distillation.

29. The method according to claim 9, wherein the vinyl monomer comprises 2-methylene-1,3-propanediol diacetate (MPDAc).
